(19) United States
(12) Patent Application Publication
(10) Pub. No.: US 2024/0150511 A1
(43) Pub. Date: May 9, 2024

(54) WEAK BASE ANION RESIN POLYMERS COMPRISING ALKYLAMINE SEGMENTS AND CROSS-LINKING SEGMENTS, AND THEIR METHODS OF USE IN ION EXCHANGE

(71) Applicant: XEROX CORPORATION, Norwalk, CT (US)

(72) Inventors: JONATHAN BACHMAN, FREMONT, CA (US); MAHATI CHINTAPALLI, MOUNTAIN VIEW, CA (US); GABRIEL IFTIME, NEWARK, CA (US); IGNACIO LOPEZ PENA, SAN FRANCISCO, CA (US); FATEMEH OSTADHOSSEIN, PALO ALTO, CA (US); ARAVINDH RAJAN, SUNNYVALE, CA (US); RAVI NEELAKANTAN, SAN FRANCISCO, CA (US)

(21) Appl. No.: 18/500,883

(22) Filed: Nov. 2, 2023

Related U.S. Application Data
(60) Provisional application No. 63/422,330, filed on Nov. 3, 2022.

(51) Int. Cl. C08F 226/02; B01J 41/07; B01J 41/09; B01J 41/14; B01J 47/014; B01J 47/016

(52) U.S. Cl. CPC C08F 226/02; B01J 41/07; B01J 41/09; B01J 41/14; B01J 47/014; B01J 47/016

(57) ABSTRACT

A weak base anion resin has alkylamine segments covalently bound to cross-linking segments, the alkylamine segments being selected from a group consisting of: vinylamine, N-methylvinylamine, N,N-dimethylvinylamine, N-methyl-N-ethylvinylamine, and N,N-diethylvinylamine, and the weak base anion resin including ions adsorbed to the alkylamine segments. A method for ion exchange includes providing a weak base anion resin, contacting the weak base anion resin with a solution containing ions to one of capture or adsorb ions from solution to the weak base anion resin, and regenerating the weak base anion resin. A method to capture and release an acid gas includes providing a weak base anion resin, contacting the weak base anion resin with a gas including an acid gas to one of capture or adsorb the acid gas from the gas to the weak base anion resin, and regenerating the weak base anion resin to release the acid gas.

### CROSS REFERENCE TO RELATED APPLICATION

This application claims priority to and the benefit of U.S. Provisional Patent Application No. 63/422,330, filed Nov. 3, 2022, which is incorporated herein by reference in its entirety.

### TECHNICAL FIELD

This disclosure relates to materials and methods for ion exchange, more particularly weak base anion (WBA) resins, more particularly WBA resins comprising alkylamine segments and cross-linking segments.

### BACKGROUND

Ion exchange resins are widely used in energy, material, and water production systems. These include strong acid cation (SAC), weak acid cation (WAC), strong base anion (SBA), and weak base anion (WBA) resins. WBA resins have amine functional groups, typically operate in the pH range of 0-7, and are typically regenerated with sodium hydroxide (NaOH), ammonia (NH3), or sodium carbonate (Na2CO3). A WBA resin can accept protons (H+) or other cations to form a positively charged site. WBA exchange resins adsorb free mineral acidity and are used for acid adsorption applications involving the removal of chloride, sulphate, nitrate, and other anions associated with strong acids. WBA resins are extensively used for removing organic substances from water and partial demineralization. WBA resin beds may be paired with strong base anion units for complete demineralization applications, and WBA resins are also effective as total organic carbon (TOC) barriers ahead of SBA beds. The most commonly commercially available WBA resin is based on amine-functionalized poly(styrene-co-divinylbenzene), which comprises benzylamine segments and cross-linking segments. Another commonly studied WBA resin comprises polyethyleneimine (PEI), supported on a porous inorganic substrate, the PEI comprising alkylamine segments but not comprising cross-linking segments.

WBA resins can be synthesized by polymerizing a monomers into a cross-linked polymer matrix. The most common WBA resins are based on a styrene-divinylbenzene cross-linked polymer matrix in the form of copolymer beads that have been functionalized with weakly basic amine groups, such as primary, secondary, or teriary amines.

Weakly basic functional groups have lone pairs of electrons that can interact with and selectively adsorb ions from a solution. When a solution containing ions comes into contact with a WBA resin, the ions are adsorbed onto the functional groups on the resin surface, displacing other ions or molecules that were previously adsorbed. The process of adsorption is reversible, and the ions can be released from the resin by passing a solution with a higher concentration of anions or by changing the pH of the solution. WBA resins are commonly used in water treatment and purification applications to remove negatively charged ions such as chloride, sulfate, nitrate, and bicarbonate. They are also used in the pharmaceutical industry for the purification of proteins, amino acids, and other biomolecules.

WBA resins are commonly used in water treatment processes to remove negatively charged ions from water. They are often used in combination with strong acid cation resins, which remove positively charged ions. In water treatment, weak base anion resins are used to remove anions such as bicarbonate, chloride, nitrate, and sulfate from water. These anions can be naturally occurring or may be introduced through industrial processes or agricultural practices.

The performance, mechanical durability, lifetime, and cost of the WBA resin are of primary importance when considering which resin to use in some applications. An important performance metric of the material is the ion adsorption capacity (IEC), which is correlated with the amine, the functional group moiety, loading in the WBA resin alongside the amine efficiency, the fraction of amines that participate in ion exchange. Improving the amine loading and amine efficiency results in an improved IEC. The cost of the WBA resin is dependent on the cost and availability of the starting materials, as well as ease of production. A WBA resin with improved performance and reduced cost is expected to be competitive with existing commercially available WBA resins.

An additional application of WBA resins is for rare earth element separation. Rare earth elements (REE's) are defined as 15 lanthanides (chemical elements), which are cerium (Ce), dysprosium (Dy), erbium (Er), europium (Eu), gadolinium (Gd), holmium (Ho), indium (In), lanthanum (La), lutetium (Lu), neodymium (Nd), praseodymium (Pr), samarium (Sm), terbium (Tb), thulium (Tm), ytterbium (Yb), along with scandium (Sc) and yttrium (Y), and occur together in nature and possess a similar trivalent oxidation state. Purification of REE's are conducted using numerous approaches, including using ion exchange resins, selective oxidation/reduction, fractional precipitation, fractional crystallization, vaporization, reduction-distillation, membrane electrolysis, and molecular recognition (ligands). Of particular interest here is the use of ion exchange resins in the purification of rare earth elements. Ion exchange resins demonstrate high uptake of lanthanides and actinides under dilute concentrations and can effectively extract or pre-concentrate REE's. Amine-based ion exchange resins, such as WBA resins, have been used for the selective recovery of Dy and Yb from aqueous solutions. Amine-based WBA resins have allowed the cyclic recovery of over 80% of parts per billion of REE's and around 0% of parts per million of sodium, magnesium, and calcium from an acid mine drainage solution. The tunable pore structure and functionality of WBA resins enable them to selectively separate mixtures of REE's with high recovery purity, low chemical usage and waste generation, and low cost and energy.

An additional application of WBA resins is for the removal of dyes from solution. Ion exchange resins, and in particular WBA resins, can be used to remove color from solutions, and are commonly used in the Food & Beverage and Textile industries. WBA resins have good resistance to organic fouling and are typically preferred over other types of ion exchange resins in dye or organic removal applications.

An additional application of WBA resins is for the separation of acid gases from gas streams. Acid gases, such as carbon dioxide, sulfur dioxide, and hydrogen sulfide, can be removed from gas streams using WBA resins. In their free base form, WBA resins contain weakly basic functional groups that can selectively capture acid gases from the gas stream. In their ion adsorbed form, WBA resins can adsorb the conjugate base of acid gases, such as carbonate or bicrarbonate.

### SUMMARY

According to aspects illustrated here, there is provided a weak base anion resin comprising alkylamine segments covalently bound to cross-linking segments, the alkylamine segments being selected from a group consisting of: vinylamine, N-methylvinylamine, N,N-dimethylvinylamine, N-methyl-N-ethylvinylamine, and N,N-diethylvinylamine, and the weak base anion resin further comprising ions adsorbed to the alkylamine segments.

According to aspects illustrated here, this is provided a method for ion exchange, the method comprising: providing a weak base anion resin, contacting the weak base anion resin with a solution containing ions to one of capture or adsorb ions from solution to the weak base anion resin, and regenerating the weak base anion resin, the weak base anion resin comprising alkylamine segments covalently bound to cross-linking segments, wherein the alkylamine segments are selected from a group consisting of: vinylamine, N-methylvinylamine, N,N-dimethylvinylamine, N-methyl-N-ethylvinylamine, and N,N-diethylvinylamine.

According to aspects illustrated here, there is provided a method to capture and release an acid gas, the method comprising: providing a weak base anion resin, contacting the weak base anion resin with a gas comprising an acid gas to one of capture or adsorb the acid gas from the gas to the weak base anion resin, and regenerating the weak base anion resin to release the acid gas, the weak base anion resin comprises alkylamine segments covalently bound to cross-linking segments, the alkylamine segments being selected from a group consisting of: vinylamine, N-methylvinylamine, N,N-dimethylvinylamine, N-methyl-N-ethylvinylamine, and N,N-diethylvinylamine, the weak base anion resin further comprising ions adsorbed to the alkylamine segments.

### BRIEF DESCRIPTION OF THE DRAWINGS

FIG. 1 depicts of alkylamine segments covalently bound to cross-linking segments.

FIG. 2 depicts alkylamine segments covalently bound to cross-linking segment with ion adsorption.

FIG. 3 depicts the alkylamine segments and cross-linking segments of a weak base anion (WBA) resin.

FIG. 4 depicts of the ion adsorption to a WBA resin.

FIG. 5 depicts vinyl alkylamine monomers.

FIG. 6 depicts alkylamine segments comprising an acryl or methacrylic group.

FIG. 7 depicts WBA segments wherein the alkylamine segment is also the cross-linking segment.

FIG. 8 depicts a process flow diagram for removing free mineral acidity from water.

FIG. 9 depicts cobalt ion adsorption to a WBA resin comprising poly(vinylamine-co-divinylbenzene).

### DETAILED DESCRIPTION OF THE EMBODIMENTS

Ion exchange resins with amine functionality fall into the category of weakly basic anion (WBA) resins, where the electron-rich nitrogen can adsorb acids to form a conjugate acid in the solid state. The embodiments provide a novel WBA resin comprising alkylamine segments and cross-linking segments, and its methods of use as an ion exchange resin. In one embodiment, the WBA resin comprises poly(vinylamine-co-divinylbenzene).

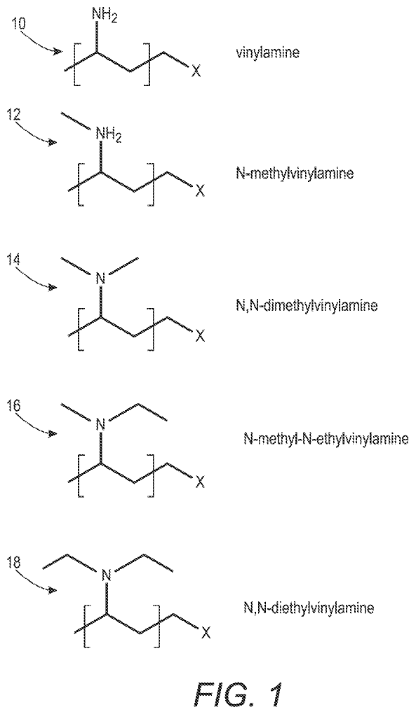

FIG. 1 shows WBA resins with alkylamine segments, in brackets, covalently bound to cross-linking segments, X. The alkylamine segments comprise vinylamine 10, N-methylvinylamine 12, N,N-diemethylamine 14, N-methyl-N-ethylvinylamine 16, and N—N-deithylvinylamine 18.

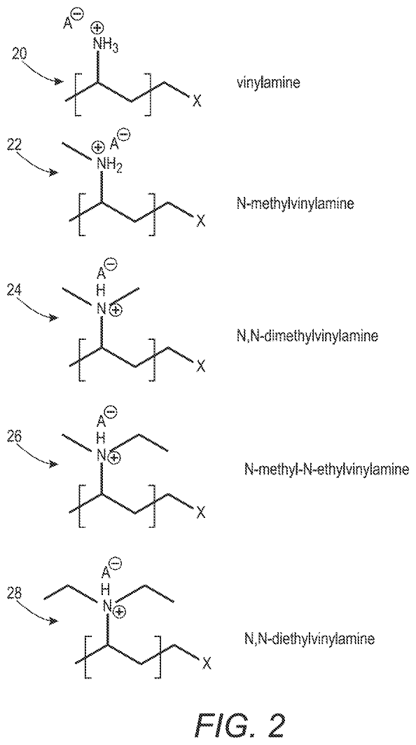

FIG. 2 shows ions adsorbed, such a H⁺, and A⁻, representing a generic anion, to WBA resins. The aklyamine segments, in brackets, are covalently bound to cross-linking segments, X. The aklyamine segments with the adsorbed ions comprise vinylamine 20, N-methylvinylamine 22, N,N-diemethylamine 24, N-methyl-N-ethylvinylamine 26, and N—N-deithylvinylamine 28.

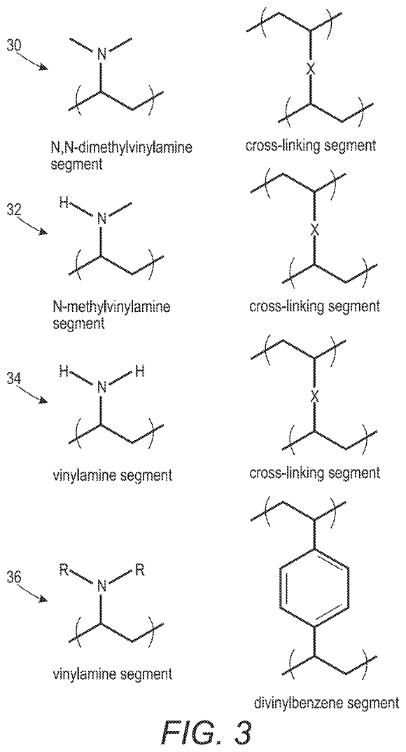

FIG. 3 shows examples of alkylamine segments and cross-linking segments. In FIG. 3, R can be H or CH₃. Diagram 30 depicts an alkylamine segment selected from N,N-dimethylvinylamine, with four carbon atoms, including two carbon from the polymerizable group and two carbons form the methyl groups, and a cross-linking segment.

Diagram 32 depicts an alkylamine segment selected from N-methylvinylamine with, three carbon atoms, including the two carbon atoms from the polymerizable group and one carbon atom from the methyl group, and a cross-linking segment.

Diagram 34 depicts an alkylamine segment selected from vinylamine, with two carbon atoms, including the two carbon atoms from the polymerizable group, and a cross-linking segment.

Diagram 36 depicts an alkylamine segments selected from vinylamine, N-methylvinylamine, and N,N-dimethylvinylamine, and cross-linking segment selected from divinylbenzene.

In some embodiments, the alkylamine segments of the WBA resin may have as many as two, as many as three, as many as four, as many as five, as many as six, or as many as seven carbon atoms in the polymer backbone.

In some embodiments, the alkylamine segments may have two carbon atoms in the polymer backbone and a primary amine, may have two carbon atoms in the polymer backbone and a secondary amine, may have two carbon atoms in the polymer backbone and a tertiary amine, may have three carbon atoms in the polymer backbone and a primary amine, may have three carbon atoms in the polymer backbone and a secondary amine, may have three carbon atoms in the polymer backbone and a tertiary amine, may have four carbon atoms in the polymer backbone and a primary amine, may have four carbon atoms in the polymer backbone and a secondary amine, may have four carbon atoms in the polymer backbone and a tertiary amine, may have five carbon atoms in the polymer backbone and a primary amine, may five two carbon atoms in the polymer backbone and a secondary amine, may have five carbon atoms in the polymer backbone and a tertiary amine, may have six carbon atoms in the polymer backbone and a primary amine, may have six carbon atoms in the polymer backbone and a secondary amine, or may have six carbon atoms in the polymer backbone and a tertiary amine,

In one embodiment, the WBA resin is poly(vinylamine-co-divinylbenzene), which comprises an alkylamine segment with two carbon atoms, and offers high ion exchange capacity (IEC) via the incorporation of low molecular weight alkylamine segments, high surface area and microporosity via the incorporation of cross-linking segments, and low-cost production via the low-cost starting materials.

In some embodiments, the alkylamine of the WBA resin is covalently bound to cross-linking segments, and non-covalently bound to ions in solution.

In some embodiments, the primary alkylamine of the WBA resin is converted to a tertiary alkylamine by treating the WBA resin with an organic acid and an aldehyde, for example formic acid and formaldehyde.

In some embodiments, the primary alkylamine of the WBA resin is converted to a tertiary alkylamine by treating the WBA resin with a methyl halide, for example methyl iodide.

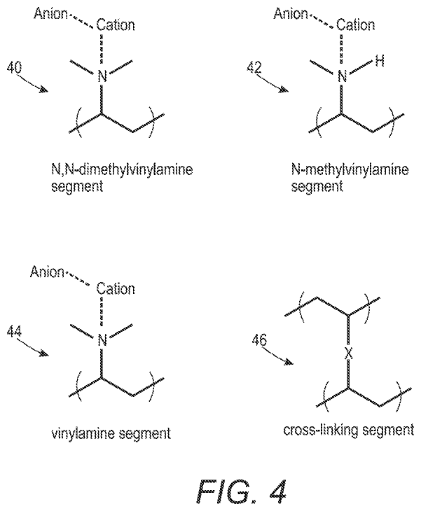

FIG. 4 shows examples of ions adsorbed by the alkylamine segments of an embodiment of the WBA resin. The alkylamine segments comprise N,N-dimethylvinylamine 40, N-methylfinylamine 42, and vinylamine 44. Diagram 40 depicts the cross-linking segment of the WBA resin.

In some embodiments, the alkylamine of the WBA resin is in its free base form.

In some embodiments, the alkylamine of the WBA resin may be a pendant group covalently bonded from the polymer backbone, for example covalently bonded to a vinyl, acrylate, or methacrylate group in monomer form.

In some embodiments, the WBA resin may contain components that are neither an alkylamine nor a crosslinker, such as components derived from additional monomers.

In some embodiments, the WBA resin comprises a secondary amine, wherein the secondary amine is produced by methylation of a poly(vinylamine-co-divinylbenzene) polymer comprising primary amines.

In some embodiments, the WBA resin comprises a tertiary amine, wherein the secondary amine is produced by methylation of a poly(vinylamine-co-divinylbenzene) polymer comprising secondary amines.

In one embodiment, the alkylamine segments of the WBA resin are primary alkylamines. In another embodiment, the alkylamine segments of the WBA resin are secondary alkylamines. In another embodiment, the alkylamine segments of the WBA resin are tertiary alkylamines.

In one embodiment, the cross-linking segment is selected from divinylbenzene. In another embodiment, the cross-linking segment is selected from a diacrylate, dimethacrylate, multifunctional acrylate crosslinker, multifunctional methacrylate crosslinker, or multifunctional crosslinker.

In some embodiments, the WBA resin comprising alkylamine segments and cross-linking segments, the alkylamine segments selected from vinylamine, N-methylvinylamine, and N,N-dimethylvinylamine, and the cross-linking segments selected from divinylbenzene, diacrylate, dimethacrylate, multifunctional acrylate crosslinker, multifunctional methacrylate crosslinker, 1,4-butanediol divinyl ether, 1,4-pentantane-3-ol, 1,4-butanediol divinyl ether, 1,4-pentantane-3-ol, and divinyl sulfone. In some embodiments, the WBA resin is selected from poly(N,N-dimethylvinylamine-co-divinylbenzene), poly(N,N-dimethylvinylamine-co-dimethacrylate), poly(N,N-dimethylvinylamine-co-diacrylate), poly(N,N-dimethylvinylamine-co-diacrylate), poly(N,N-dimethylvinylamine-co-1,4-butanediol divinyl ether), poly(N,N-dimethylvinylamine-co-1,4-pentantane-3-ol), poly(N,N-dimethylvinylamine-co-1,4-butanediol divinyl ether), poly(N,N-dimethylvinylamine-co-1,4-pentantane-3-ol), poly(N,N-dimethylvinylamine-co-divinyl sulfone).

Generally, the WBA resin will result from a polymerization reaction initiated on a precursor solution that contains various monomers and other optional components, depending upon the monomers used and the nature of the polymerization reaction. In some embodiments, the WBA resin may be produced using radical polymerization, controlled radical polymerization, or condensation polymerization. The precurors are selected based on their compatibility with the particular type of reaction. For example, the precursors may be compatible with radical polymerization, controlled radical polymerization, or condensation polymerization. Precursors include monomers, crosslinkers, and, or other components from which atoms covalently bound in the WBA structure originate, including, but not limited to initiators, chain transfer agents, or radical mediators.

Some embodiments may synthesize the WBA resin from a form of radical polymerization of a vinyl-containing linear monomer and a divinyl-containing cross-linking monomer. The radical polymerization may involve mixing a vinyl-containing linear monomer, a divinyl-containing cross-linking monomer, a radical initiator, and a solvent to produce a liquid monomer solution. Polymerization of the the liquid monomer solution would involve decomposition of the radical initiator through application of some form of energy, such as heat or light, to produce the WBA resin.

In some embodiments of the WBA resin being polymerized from a vinyl-containing linear monomer and a divinyl-containing cross-linking monomer, the WBA resin is synthesized from the radical polymerization of vinylformamide and divinylbenzene. The vinylformamide, divinylbenzene, a solvent, and a radical initiator are mixed to form a liquid monomer solution. Application of heat causes polymerization of the liquid monomer solution to form poly(vinylformamide-co-divinylbenzene), the poly(vinylformamide-co-divinylbenzene) comprising formamide moieties, wherein further the formamide moieties are converted to amine moieties via deprotection or hydrolysis using acid (e.g., HCl or HNO₃) or base (e.g., NaOH or KOH), wherein the WBA resin comprises poly(vinylamine-co-divinylbenzene).

Deprotection may be conducted using an acid wash, such as HCl, to create H₊NH₂ moieties in the polymer. To neutralize the H⁺NH₂ polymer to create the neutral NH₂ free-base moiety, a base can be added. Deprotection can also be accomplished via base wash, such as NaOH, to yield the free base form. This type of procedure using vinylformamide can be extended to other cross-linking segments, other such as those listed in the WBA resin section, to create a variety of vinylamine-containing cross-linked polymers. The solvent and the radical initiator can be selected from a broad range of compounds that are compatible with the polymerization. In some embodiments, the solvent is selected from selected from polar solvents, non-polar solvents, polar aprotic solvents, or non-polar aromatic solvents. In some embodiments, the initiator is selected from 2,2′-azobis(2-methylpropionitrile) (AIBN), benzoyl peroxide, or other initiators.

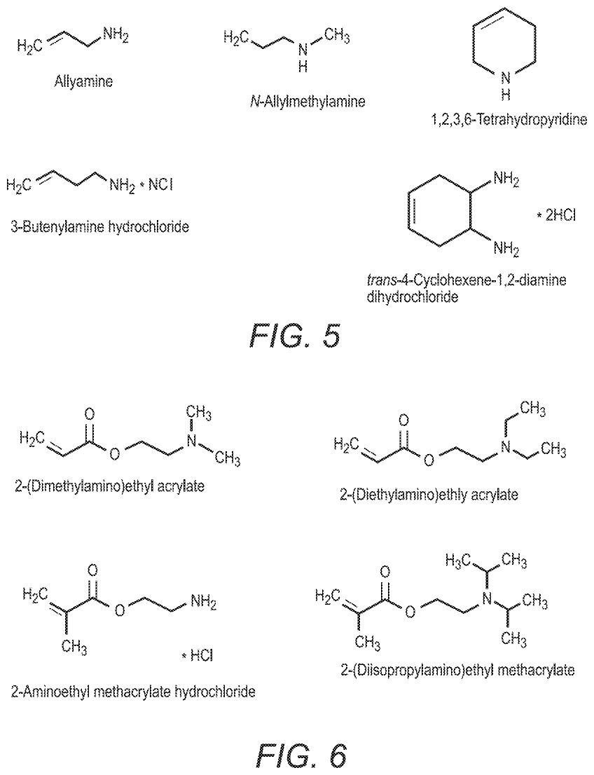

In some embodiments, radical polymerization monomers having a polymerizable double bond are provided for copolymerization. The amine comprising monomer may be an aliphatic unsaturated amine. For the purpose of radical polymerization the amine groups are protected for example with formamide groups. FIG. 5 shows examples of vinyl alkylamine monomers. Only the amine form of the monomer is shown, but it should be understood that the amine can be protected for the purpose for polymerization (e.g. vinylformamide).

In some embodiments, the amine comprising monomer may be an aliphatic unsaturated amine wherein the polymerizable group is an acryl or methacrylic group. FIG. 6 shows some examples.

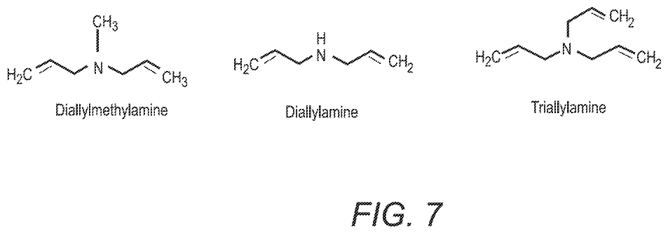

In some embodiments, the alkylamine monomer may be multifunctional, performing both the role of crosslinker and alkylamine monomer. FIG. 7 shows examples.

The embodiments provide a method to capture or release ions, the method comprising contacting a solution with a polymer, wherein the polymer comprises alkylamine segments covalently bound to cross-linking segments, wherein the solution comprises ions, and wherein ions are captured from the solution to the polymer or released from the polymer to the solution.

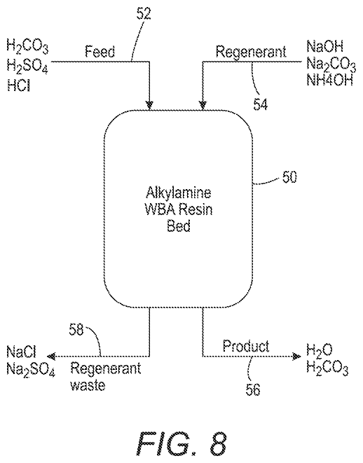

In some embodiments, the WBA resin is used to remove free mineral acids from water. FIG. 8 shows an embodiment of a process flow for removing free mineral acidity from water. The WBA resin bed 50 comprises an embodiment of a WBA resin comprising alkylamine segments. A feed solution, such as carbonic acid, (H₂CO₃), sulfuric acid (H₂SO₄), or hydrochloric acid (HCL), among many others, is fed into the WBA resin bed or other sorbent. The sorbent bed captures the ions, removing them from the solution, to produce water among other products. The sorbent bed can undergo regeneration as needed, similar to other sorbent beds, using various solutions such as sodium hydroxide, sodium carbonate or ammonium hydroxide, as examples from many other possible regeneration solutions. The regenerate waste such as sodium chloride or sodium sulfate, as examples, carries off the ions previously adsorbed, “cleaning” the resin sorbent bed for further use.

In some embodiments, the WBA resin is used to remove metals from water.

In some embodiments, the WBA resin adsorbs ions in the pH range of 0-11.

In some embodiments, the WBA is regenerated at a pH greater than 5, greater than 5.5, greater than 6, greater than 6.5, greater than 7, greater than 7.5, or greater than 8.

In some embodiments, the WBA is regenerated using hydroxide, carbonate, bicarbonate, or ammonia.

In some embodiments, the WBA is regenerated using acid, e.g, HCl, HNO₃, H₂SO₄, H₂CO₃, acetic acid, citric acid, or another acid.

In some embodiments, the WBA is regenerated at a pH lower than 5, lowr than 4.5, lower than 4, lower than 3.5, lower than 3, lower than 2.5, lower than 2, lower than 2.5, lower than 2, lower than 1.5, lower than 1, or lower than 0.5.

In some embodiments the WBA resin is operated in a liquid other than water such as a protic solvent, alcohol, or solvent.

In some embodiments, the WBA is used to capture or release a proton, an inorganic cation, an organic acid, a metal cation, Li(I), Na(I), K(I), Cu(I), Rb(I), Ag(I), Cs(I), Au(I), Hg(I), Tl(I), At(I), Fr(I), Be(II), Mg(II), Ca(II), Ti(II), Cr(II), Mn(II), Fe(II), Co(II), Ni(II), Cu(II), Zn(II), Ge(II), Sr(II), Pd(II), Cd(II), Sn(II), Te(II), Ba(II), Pt(II), Hg(II), Pb(II), Po(II), Ra(II), Eu(II), S(II), Yb(II), No(II), Sc(III), Ti(III), V(III), Cr(III), Mn(III), Fe(III), Co(III), Ni(III), Ga(III), As(III), Y(III), Nb(III), Ru(III), In(III), Sb(III), La(III), Os(III), Ir(III), Au(III), Tl(III), Bi(III), Ac(III), Ce(III), Pr(III), Nd(III), Pm(III), Sm(III), Eu(III), Gd(III), Tb(III), Dy(III), Ho(III), Er(III), Tm(III), Yb(III), Lu(III), U(III), Np(III), Pu(III), Am(III), Cm(III), Bk(III), Cf(III), Es(III), Fm(III), Md(III), No(III), Lr(III), Ti(IV), V(IV), Mn(IV), Ge(IV), Zr(IV), Tc(IV), Pd(IV), Sn(IV), Te(IV), Hf(IV), Re(IV), Os(IV), Ir(IV), Pt(IV), Pb(IV), Po(IV), Ce(IV), Pa(IV), U(IV), Np(IV), Pu(IV), Am(IV), and Bk(IV), V(V), As(V), Nb(V), Sb(V), Ta(V), Bi(V), Pa(V), U(V), Np(V), Pu(V), Am(V), Cr(VI), Mo(VI), Tc(VI), Te(VI), W(VI), Re(VI), U(VI), Np(VI), Pu(VI), Am(VI), Mn(VII), Tc(VII), Re(VII), a rare earth element, lanthanum, cerium, praseodymium, neodymium, promethium, samarium, europium, gadolinium, terbium, dysprosium, holmium, erbium, thulium, ytterbium, lutetium, scandium, yttrium, or a dye.

In some embodiments, the WBA resin is used to capture or release a dye, the dye selected from anthraquinone, triarylmethane, nitro, azo, xanthene, acridine, pyronin, acridine, phthalocyanine, fluorone, caroenoid, thiazin, benzanthrone, diazo, oxazin, merocyanine, diazonium salt, thiazol, quinoline, safranin, stilbene, violanthrone, inorganic, and natural dye.

In some embodiments, the WBA resin is used to capture or release a free mineral acid, the free mineral acid selected from F—, Cl—, Br—, I—, At—, O2-, S2-, Se2-, Te2-, Po2-, As3-, Sb3-, nitrate, suflate, nitrite, acetate, borate, bromate, chlorate, chlorite, chromate, cyanamide, cyanide, dichromate, dihydrogen phosphate, hydrogen phosphate, phosphate, ferricyanide, ferrocyanide, hydrogen carbonate, hydrogen sulfate, hydrogen sulfide, and hydrogen sulfite.

In some embodiments, the WBA is used to capture or release a negatively charged coordination complex ion. The central atom may be a transition metal ion (Ti, V, Cr, Mn, Fe, Co, Ni, Cu, Zn, Zr, Nb, Mo, Tc, Ru, Rh, Pd, Ag, Cd, Hf, Ta, W, Re, Os, Ir, Pt, Au, Hg, Rf, Db, Sg, Bh, Mt, Ds, Rg, Cn), a lanthanide ion (Sc, Ce, Pr, Nd, Pm, Sm, Eu, Gd, Tb, Dy, Ho, Er, Tm, Yb, Lu) or an actinide ion (Th, Pa, U, Np, Pu, Am, Cm, Bk, Cf, Es, Fm, Md, No, Lr) in any of their oxidation states. The coordination complex is formed between at least one of the mentioned central atoms and at least one neutral or negatively charged ligand. The sum of the negative charges on all the ligands is greater than the positive oxidation state of the central metal atom making the coordination complex negatively charged. Ligands may be monodentate (ammonia, cyanide, thiocyanate, water, fluoride, chloride, bromide, iodide, hydroxide, carbon monoxide), bidentate (ethylenediamine, bipyridine, phenanthroline, oxalate), tridentate (diethylenetriamine), tetradentate (tris(2-aminoethyl)amine, triethylenetetramine, porphin), hexadentate (ethylenediaminetetraacetate), or octadentate (diethylenetriaminepentaacetate).

In some embodiments, the WBA resin is used to capture or release an organic acid, wherein the organic acid is selected from lactic acid, acetic acid, formic acid, citric acid, oxalic acid, uric acid, malic acid, tartaric acid, carboxylic acid, sulfonic acid phenol, enol, alcohol, and thiol.

In some embodiments, the WBA resin is used to capture or release an acid gas, the acid gas selected from sulfur oxide, sulfur monoxide, sulfur dioxide, sulfur trioxide, nitrogen oxide, nitrogen dioxide, nitrogen trioxide, nitrous oxide, dinitrogen dioxide, dinitrogen trioxide, dinitrogen tetroxide, dinitrogen pentoxide, nitrosylazide, oxatetrazol, trinitramide, hydrogen sulfide, and carbon dioxide.

In some embodiments, the WBA resin is used in a demineralization process, the demineralization process comprising providing a WBA resin, the WBA resin comprising alkylamine segments and cross-linking segments; contacting the WBA resin with a water comprising a mineral acid or organic; capturing the mineral acid or organic from the water and adsorbing the mineral acid or organic to the WBA resin; regenerating the WBA resin by applying a base to the WBA resin.

In some embodiments, the WBA resin is used in a demineralization process, the demineralization process comprising flowing a water stream comprising a mineral acid or organic into a WBA resin bed, wherein the WBA resin bed comprises a WBA resin, the WBA resin comprising alkylamine segments and cross-linking segments, the demineralization process further comprising flowing water to a strong base anion (SBA) resin bed.

In some embodiments, the WBA resin is used in a demineralization process, the demineralization process comprising flowing a water stream comprising a mineral acid or organic into a WBA resin bed, wherein the WBA resin bed comprises a WBA resin, the WBA resin comprising alkylamine segments and cross-linking segments, the demineralization process further comprising flowing water to a strong acid cation (SAC) resin bed.

In some embodiments, the WBA resin is used in a method to capture rare earth elements, the method comprising providing a WBA resin, the WBA resin comprising alkylamine segments and cross-linking segments, contacting an aqueous solution comprising rare earth elements with the WBA resin, capturing the rare earth elements in the WBA resin via binding of the rare earth element to the alkylamine, and subsequently releasing the rare earth elements from the WBA resin via regeneration.

In some embodiments, the WBA resin is used in a method to separate two or more rare earth elements, the method comprising providing a WBA resin, the WBA resin comprising alkylamine segments and cross-linking segments, contacting an aqueous solution comprising at least two types of rare earth elements with the WBA resin, wherein the WBA resin selectively adsorbs one of the two types of rare earth elements, and subsequently releasing the adsorbed rare earth element from the WBA resin via regeneration.

In some embodiments, the WBA resin is used in a method to separate actinides from lanthanides, the method comprising providing a WBA resin, the WBA resin comprising an alkylamine segment and a cross-linking segment, contacting an aqueous solution comprising actinides and lanthanides with the WBA resin, selectively adsorbing the actinides from the aqueous solution to the WBA resin, and subsequently releasing the actinides from the WBA resin via regeneration.

In some embodiments, the WBA resin is used in a method to separate one lanthanide element from another lanthanide element, the method comprising providing a WBA resin, the WBA resin comprising an alkylamine segment and a cross-linking segment, contacting an aqueous solution comprising at least two lanthanide elements with the WBA resin, selectively adsorbing one lanthanide element from solution comprising at least two lanthanide elements, and subsequently releasing the adsorbed lanthanide element via regeneration.

In some embodiments, the WBA resin is used to separate neodymium from dysprosium, the method comprising providing a WBA resin, the WBA resin comprising an alkylamine segment and a cross-linking segment, contacting an aqueous solution comprising neodymium and dysprosium with the WBA resin, selectively adsorbing dysprosium from solution comprising neodymium and dysprosium, and subsequently releasing the dysprosium via regeneration.

In some embodiments, the WBA resin is used to separate neodymium from dysprosium, the method comprising providing a WBA resin, the WBA resin comprising an alkylamine segment and a cross-linking segment, contacting an aqueous solution comprising neodymium and dysprosium with the WBA resin, selectively adsorbing neodymium from solution comprising neodymium and dysprosium, and subsequently releasing neodymium via regeneration.

In some embodiments, the WBA resin is used to separate neodymium from praseodymium, the method comprising providing a WBA resin, the WBA resin comprising an alkylamine segment and a cross-linking segment, contacting an aqueous solution comprising neodymium and dysprosium with the WBA resin, selectively adsorbing neodymium from solution comprising neodymium and praseodymium, and subsequently releasing neodymium via regeneration.

In some embodiments, the WBA resin is used to separate neodymium from praseodymium, the method comprising providing a WBA resin, the WBA resin comprising an alkylamine segment and a cross-linking segment, contacting an aqueous solution comprising neodymium and dysprosium with the WBA resin, selectively adsorbing praseodymium from solution comprising neodymium and praseodymium, and subsequently releasing praseodymium via regeneration.

In some embodiments, the WBA resin is used in a method to separate one transition metal element from another transition metal element, the method comprising providing a WBA resin, the WBA resin comprising an alkylamine segment and a cross-linking segment, contacting an aqueous solution comprising at least two transition metal elements with the WBA resin, selectively adsorbing one transition metal element from solution comprising at least two transition metal elements, and subsequently releasing the adsorbed transition metal element via regeneration.

In some embodiments, the WBA resin is used in a method to remove selected pharmaceuticals from water, the method comprising providing a WBA resin, the WBA resin comprising an alkylamine segment and a cross-linking segment, contacting an aqueous solution comprising at least two pharmaceutical compounds with the WBA resin, and selectively adsorbing at least one of the at least two pharmaceutical compounds.

In some embodiments, the pharmaceutical compounds are selected from Acetaminophen, Atenolol, Carbamazepine, Clofibric acid, Diclofenac, Estrone, Gemfibrozil, Ibuprofen, Iopromide, Ketoprofen, Sulfamethoxazol, and Trimethoprim.

In some embodiments, the ion adsorption to the WBA resin occurs at a pH of less than 11, less than 10.5, less than 10, less than 9.5, less than 9, less than 8.5, less than 8, less than 7.5, less than 7, less than 6.5, less than 6, less than 5.5, less than 5, less than 4.5, less than 4, less than 3.5, less than 3, less than 2.5, less than 2, less than 1.5, less than 1, less than 0.5, or less than 0.

In some embodiments, the WBA resin is used as a sensor to detect ions, the method comprising contacting a WBA resin with a solution containing ions.

### EXAMPLES

### Example 1: Synthesis of a Poly(Vinylamine-Co-Divinylbenzene) WBA Resin Comprising Primary Alkylamine Segments and Divinylbenzene Cross-Linking Segments

To a 20 mL vial, 2.703 g vinylformamide, 0.3 g divinylbenzene, 12.027 g organic solvent, and 0.036 g AIBN were added to form the monomer solution. The monomer solutions were placed in an oven at 90° C. for three hours to form a polymer hydrogel comprising poly(vinylformamide-co-divinylbenzene). The polymer hydrogel was washed with water and filtered, then added to 150 mL of 4 M HCl for deprotection to form the WBA resin poly(vinylamine-co-divinylbenzene). The WBA resin was subsequently washed with water and sodium bicarbonate to create the free base form of the primary alkylamine poly(vinylamine-co-divinylbenzene).

### Example 2: Methylation of the WBA Resin Comprising Primary Alkylamine Segments and Cross-Linking Segments, Poly(Vinylamine-Co-Divinylbenzene) to Form the WBA Resin Comprising Tertiary Primaryamines, Poly(N,N-Dimethylvinylamine-Co-Divinylbenzene), Using Formic Acid

Methylation of the primary alkylamine containing WBA resin, poly(vinylamine-co-divinylbenzene) was conducted via a Eschweiler-Clarke reaction. In a 20 mL vial, approximately 1 g (9 mmol N) of dry WBA resin was added to a stirring solution of 45 mmol formic acid and 20 mmol of formaldehyde (35% solution) in an ice bath. The mixture was then heated under reflux for 8 h, and all excess formaldehyde and formic acid were evaporated using the rotary evaporator to yield the tertiary alkylamine containing WBA resin poly(N,N-dimethylvinylamine-co-divinylbenzene).

### Example 3: Methylation of the WBA Resin Comprising Primary Alkylamine Segments and Cross-Linking Segments, Poly(Vinylamine-Co-Divinylbenzene) to Form the WBA Resin Comprising Tertiary Primaryamines, Poly(N,N-Dimethylvinylamine-Co-Divinylbenzene), Using Methyl Iodide

Methylation of the Primary Amines in the WBA Resin Via Methyl Iodide Addition

In a two-neck 50 mL round bottom flask with jacketed condenser, approximately 2 g of WBA resin (18 mmol N) were mixed in 20 nL acetone in an ice bath. After 8 equivalents of methyl iodide (˜20 g/144 mmol) were added dropwise to the stirring mixture. The reaction vessel was kept on ice and left to react for 8 h. The remaining methyl iodide and acetone were removed by rotary evaporation to yield the teriary alkylamine containing WBA resin poly(N,N-dimethylvinylamine-co-divinylbenzene).

### Example 4: Use of the WBA Resin Comprising Primary Alkylamines, Poly(Vinylamine-Co-Divinylbenzene), for Metal Adsorption

To each of seven 20 mL vials, a certain mass of WBA resin comprising primary alkylamines, poly(vinylamine-co-divinylbenzene), and certain volume of aqueous solution comprising a measured initial [Co(II)] (as Co(NO₃)₂·6H₂O) were added. The difference between the initial and final [Co(II)], along with the volume of solution and mass of adsorbent was used to determine the Co(II) loading in the polymer. [Co(II)] was determined via UV-vis spectroscopy using the absorption at 511 nm.

| | Polymer | Solution | [Co(II)] | [Co(II)] | Co(II) adsorbed |
|---|---|---|---|---|---|
| | mass | volume | initial | final | (mmol Co(II)/ |
| Vial | (g) | (mL) | (mM) | (mM) | g polymer) |
| 1 | 0.1001 | 15.012 | 5.189 | 3.307 | 0.282 |
| 2 | 0.1019 | 15.026 | 9.950 | 6.983 | 0.438 |
| 3 | 0.1002 | 15.075 | 20.135 | 16.172 | 0.596 |
| 4 | 0.1014 | 15.107 | 30.210 | 26.025 | 0.623 |
| 5 | 0.1026 | 15.143 | 40.727 | 36.122 | 0.680 |
| 6 | 0.1046 | 15.971 | 60.190 | 55.584 | 0.703 |
| 7 | 0.1002 | 15.614 | 81.181 | 76.597 | 0.714 |

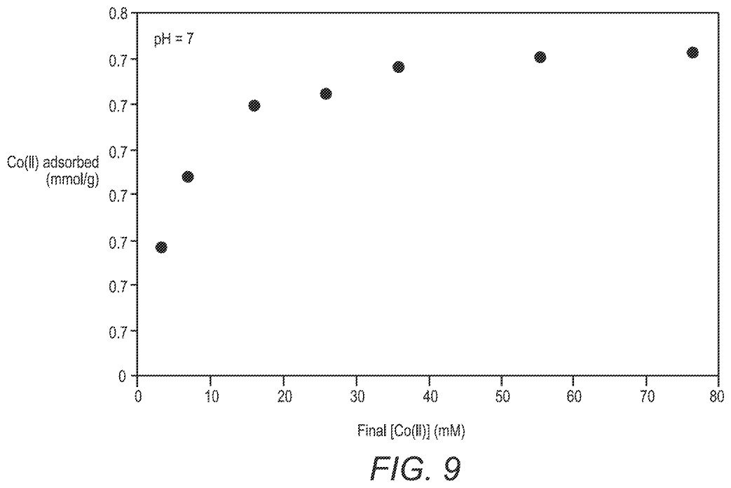

A specific experiment under Example 4 involved preparing 7 vials, each with ˜15 g of an aqueous solution comprising Co(NO3)2·6H2O at various initial concentrations and neutral pH, then adding ˜0.1 g of the WBA resin comprising poly(vinylamine-co-divinylbenzene) to each vial. The solutions were mixed for ˜20 h, and then the supernatant was separated from the WBA resin with a syringe filter. The initial and final concentrations of the Co solution were measured using UV-vis, and the difference in concentration was used to determine the Co adsorption to the WBA resin, which showed a maximum of 0.714 mmol Co(II)/g polymer. FIG. 9 shows the results.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the above discussion.

1. A weak base anion resin comprising:
alkylamine segments covalently bound to cross-linking segments, the alkylamine segments being selected from a group consisting of: vinylamine, N-methylvinylamine, N,N-dimethylvinylamine, N-methyl-N-ethylvinylamine, and N,N-diethylvinylamine, and the weak base anion resin further comprises ions adsorbed to the alkylamine segments.

2. The weak base anion resin as claimed in claim 1, wherein:
the cross-linking segments comprise divinylbenzene, and
the weak base anion resin comprises a polymer selected from a group consisting of: poly(vinylamine-co-divinylbenzene), poly(N-methylvinylamine-co-divinylbenzene), poly(N,N-dimethylvinylamine-co-divinylbenzene), poly(N-methyl-N-ethylvinylamine-co-divinylbenzene), and poly(N,N-diethylvinylamine-co-divinylbenzene).

3. The weak base anion resin as claimed in claim 1, wherein the cross-linking segments are selected from a group consisting of: diacrylate, dimethacrylate, 1,4-butanediol divinyl ether, 1,4-pentantane-3-ol, 1,4-butanediol divinyl ether, 1,4-pentantane-3-ol, and divinyl sulfone, and wherein the weak base anion resin comprises a polymer selected from a group consisting of: poly(vinylamine-co-dimethacrylate), poly(vinylamine-co-diacrylate), poly(vinylamine-co-1,4-butanediol divinyl ether), poly(vinylamine-co-1,4-pentantane-3-ol), poly(vinylamine-co-divinyl sulfone), poly(N-methylvinylamine-co-dimethacrylate), poly(N-methylvinylamine-co-diacrylate), poly(N-methylvinylamine-co-1,4-butanediol divinyl ether), poly(N-methylvinylamine-co-1,4-pentantane-3-ol), poly(N-methylvinylamine-co-divinyl sulfone), poly(N,N-dimethylvinylamine-co-dimethacrylate), poly(N,N-dimethylvinylamine-co-diacrylate), poly(N,N-dimethylvinylamine-co-1,4-butanediol divinyl ether), poly(N,N-dimethylvinylamine-co-1,4-pentantane-3-ol), poly(N,N-dimethylvinylamine-co-1,4-pentantane-3-ol), poly(N,N-dimethylvinylamine-co-divinyl sulfone), poly(N-methyl-N-ethylvinylamine-co-dimethacrylane), poly(N-methyl-N-ethylvinylamine-co-diacrylate), poly(N-methyl-N-ethylvinylamine-co-1,4-butanediol divinyl ether), poly(N-methyl-N-ethylvinylamine-co-1,4,-pentane-3-ol), poly(N-methyl-N-ethylvinylamine-co-divinyl sulfone), poly(N,N-diethylvinylamine-co-dimethacrylane), poly(N-methyl-N-ethylvinylamine-co-diacrylate), poly(N,N-diethylvinylamine-co-1,4-butanediol divinyl ether), and poly(N,N-diethylvinylamine-co-1,4,-pentane-3-ol), and poly(N,N-diethylvinylamine-co-divinyl sulfone).

4. The weak base anion resin as claimed in claim 1, wherein the ions comprise an anion and a cation, and the cation is selected from a group consisting of: a proton, an inorganic cation, an organic acid, a metal cation, Li(I), Na(I), K(I), Cu(I), Rb(I), Ag(I), Cs(I), Au(I), Hg(I), Tl(I), At(I), Fr(I), Be(II), Mg(II), Ca(II), Ti(II), Cr(II), Mn(II), Fe(II), Co(II), Ni(II), Cu(II), Zn(II), Ge(II), Sr(II), Pd(II), Cd(II), Sn(II), Te(II), Ba(II), Pt(II), Hg(II), Pb(II), Po(II), Ra(II), Eu(II), Sm(II), Yb(II), No(II), Sc(III), Ti(III), V(III), Cr(III), Mn(III), Fe(III), Co(III), Ni(III), Ga(III), As(III), Y(III), Nb(III), Ru(III), In(III), Sb(III), La(III), Os(III), Ir(III), Au(III), Tl(III), Bi(III), Ac(III), Ce(III), Pr(III), Nd(III), Pm(III), Sm(III), Eu(III), Gd(III), Tb(III), Dy(III), Ho(III), Er(III), Tm(III), Yb(III), Lu(III), U(III), Np(III), Pu(III), Am(III), Cm(III), Bk(III), Cf(III), Es(III), Fm(III), Md(III), No(III), Lr(III), Ti(IV), V(IV), Mn(IV), Ge(IV), Zr(IV), Tc(IV), Pd(IV), Sn(IV), Te(IV), Hf(IV), Re(IV), Os(IV), Ir(IV), Pt(IV), Pb(IV), Po(IV), Ce(IV), Pa(IV), U(IV), Np(IV), Pu(IV), Am(IV), and Bk(IV), V(V), As(V), Nb(V), Sb(V), Ta(V), Bi(V), Pa(V), U(V), Np(V), Pu(V), Am(V), Cr(VI), Mo(VI), Tc(VI), Te(VI), W(VI), Re(VI), U(VI), Np(VI), Pu(VI), Am(VI), Mn(VII), Tc(VII), Re(VII), a rare earth element, lanthanum, cerium, praseodymium, neodymium, promethium, samarium, europium, gadolinium, terbium, dysprosium, holmium, erbium, thulium, ytterbium, lutetium, scandium, yttrium, and a dye.

5. The weak base anion resin as claimed in claim 1, wherein:
the cross-linking segments comprise divinylbenzene,
the weak base anion resin comprises a polymer selected from a group consisting of: poly(vinylamine-co-divinylbenzene), poly(N-methylvinylamine-co-divinylbenzene), poly(N,N-dimethylvinylamine-co-divinylbenzene), poly(N-methyl-N-ethylvinylamine-co-divinylbenzene), and poly(N,N-diethylvinylamine-co-divinylbenzene), and
the ions comprise an anion and a cation, and the cation is selected from a group consisting of: a proton, an inorganic cation, an organic acid, a metal cation, Li(I), Na(I), K(I), Cu(I), Rb(I), Ag(I), Cs(I), Au(I), Hg(I), Tl(I), At(I), Fr(I), Be(II), Mg(II), Ca(II), Ti(II), Cr(II), Mn(II), Fe(II), Co(II), Ni(II), Cu(II), Zn(II), Ge(II), Sr(II), Pd(II), Cd(II), Sn(II), Te(II), Ba(II), Pt(II), Hg(II), Pb(II), Po(II), Ra(II), Eu(II), Sm(II), Yb(II), No(II), Sc(III), Ti(III), V(III), Cr(III), Mn(III), Fe(III), Co(III), Ni(III), Ga(III), As(III), Y(III), Nb(III), Ru(III), In(III), Sb(III), La(III), Os(III), Ir(III), Au(III), Tl(III), Bi(III), Ac(III), Ce(III), Pr(III), Nd(III), Pm(III), Sm(III), Eu(III), Gd(III), Tb(III), Dy(III), Ho(III), Er(III), Tm(III), Yb(III), Lu(III), U(III), Np(III), Pu(III), Am(III), Cm(III), Bk(III), Cf(III), Es(III), Fm(III), Md(III), No(III), Lr(III), Ti(IV), V(IV), Mn(IV), Ge(IV), Zr(IV), Tc(IV), Pd(IV), Sn(IV), Te(IV), Hf(IV), Re(IV), Os(IV), Ir(IV), Pt(IV), Pb(IV), Po(IV), Ce(IV), Pa(IV), U(IV), Np(IV), Pu(IV), Am(IV), and Bk(IV), V(V), As(V), Nb(V), Sb(V), Ta(V), Bi(V), Pa(V), U(V), Np(V), Pu(V), Am(V), Cr(VI), Mo(VI), Tc(VI), Te(VI), W(VI), Re(VI), U(VI), Np(VI), Pu(VI), Am(VI), Mn(VII), Tc(VII), Re(VII), a rare earth element, lanthanum, cerium, praseodymium, neodymium, promethium, samarium, europium, gadolinium, terbium, dysprosium, holmium, erbium, thulium, ytterbium, lutetium, scandium, yttrium, and a dye.

6. The weak base anion resin as claimed in claim 1, wherein:
the cross-linking segments are selected from a group consisting of: diacrylate, dimethacrylate, 1,4-butanediol divinyl ether, 1,4-pentantane-3-ol, 1,4-butanediol divinyl ether, 1,4-pentantane-3-ol, and divinyl sulfone,
the weak base anion resin comprises a polymer selected from a group consisting of: poly(vinylamine-co-dimethacrylate), poly(vinylamine-co-diacrylate), poly(vinylamine-co-1,4-butanediol divinyl ether), poly(vinylamine-co-1,4-pentantane-3-ol), poly(vinylamine-co-divinyl sulfone), poly(N-methylvinylamine-co-dimethacrylate), poly(N-methylvinylamine-co-diacrylate), poly(N-methylvinylamine-co-1,4-butanediol divinyl ether), poly(N-methylvinylamine-co-1,4-pentantane-3-ol), poly(N-methylvinylamine-co-divinyl sulfone), poly(N,N-dimethylvinylamine-co-dimethacrylate), poly(N,N-dimethylvinylamine-co-diacrylate), poly(N,N-dimethylvinylamine-co-1,4-butanediol divinyl ether), poly(N,N-dimethylvinylamine-co-1,4-pentantane-3-ol), poly(N,N-dimethylvinylamine-co-1,4-pentantane-3-ol), poly(N,N-dimethylvinylamine-co-divinyl sulfone), poly(N-methyl-N-ethylvinylamine-co-dimethacrylane), poly(N-methyl-N-ethylvinylamine-co-diacrylate), poly(N-methyl-N-ethylvinylamine-co-1,4-butanediol divinyl ether), poly(N-methyl-N-ethylvinylamine-co-1,4,-pentane-3-ol), poly(N-methyl-N-ethylvinylamine-co-divinyl sulfone), poly(N,N-diethylvinylamine-co-dimethacrylane), poly(N-methyl-N-ethylvinylamine-co-diacrylate), poly(N,N-diethylvinylamine-co-1,4-butanediol divinyl ether), and poly(N,N-diethylvinylamine-co-1,4,-pentane-3-ol), poly(N,N-diethylvinylamine-co-divinyl sulfone), and
the ions comprise an anion and a cation, and the cation is selected from a group consisting of: a proton, an inorganic cation, an organic acid, a metal cation, Li(I), Na(I), K(I), Cu(I), Rb(I), Ag(I), Cs(I), Au(I), Hg(I), Tl(I), At(I), Fr(I), Be(II), Mg(II), Ca(II), Ti(II), Cr(II), Mn(II), Fe(II), Co(II), Ni(II), Cu(II), Zn(II), Ge(II), Sr(II), Pd(II), Cd(II), Sn(II), Te(II), Ba(II), Os(III), Ir(III), Au(III), Tl(III), Bi(III), Ac(III), Ce(III), Pr(III), Nd(III), Pm(III), Sm(III), Eu(III), Gd(III), Tb(III), Dy(III), Ho(III), Er(III), Tm(III), Yb(III), Lu(III), U(III), Np(III), Pu(III), Am(III), Cm(III), Bk(III), Cf(III), Es(III), Fm(III), Md(III), No(III), Lr(III), Ti(IV), V(IV), Mn(IV), Ge(IV), Zr(IV), Tc(IV), Pd(IV), Sn(IV), Te(IV), Hf(IV), Re(IV), Os(IV), Ir(IV), Pt(IV), Pb(IV), Po(IV), Ce(IV), Pa(IV), U(IV), Np(IV), Pu(IV), Am(IV), and Bk(IV), V(V), As(V), Nb(V), Sb(V), Ta(V), Bi(V), Pa(V), U(V), Np(V), Pu(V), Am(V), Cr(VI), Mo(VI), Tc(VI), Te(VI), W(VI), Re(VI), U(VI), Np(VI), Pu(VI), Am(VI), Mn(VII), Tc(VII), Re(VII), a rare earth element, lanthanum, cerium, praseodymium, neodymium, promethium, samarium, europium, gadolinium, terbium, dysprosium, holmium, erbium, thulium, ytterbium, lutetium, scandium, yttrium, and a dye.

7. A method for ion exchange, the method comprising:
providing a weak base anion resin;
contacting the weak base anion resin with a solution containing ions to one of either capture or adsorb ions from solution to the weak base anion resin; and
regenerating the weak base anion resin, the weak base anion resin comprising alkylamine segments covalently bound to cross-linking segments, and the alkylamine segments are selected from a group consisting of: vinylamine, N-methylvinylamine, N,N-dimethylvinylamine, N-methyl-N-ethylvinylamine, and N,N-diethylvinylamine.

8. The method as claimed in claim 7, wherein:
the cross-linking segments comprise divinylbenzene, and the weak base anion resin comprises a polymer selected from a group consisting of: poly(vinylamine-co-divinylbenzene), poly(N-methylvinylamine-co-divinylbenzene), poly(N,N-dimethylvinylamine-co-divinylbenzene), poly(N-methyl-N-ethylvinylamine-co-divinylbenzene), and poly(N,N-diethylvinylamine-co-divinylbenzene).

9. The method as claimed in claim 7, wherein:
the cross-linking segments are selected from a group consisting of: diacrylate, dimethacrylate, 1,4-butanediol divinyl ether, 1,4-pentantane-3-ol, 1,4-butanediol divinyl ether, 1,4-pentantane-3-ol, and divinyl sulfone, and
the weak base anion resin comprises a polymer selected from a group consisting of: poly(vinylamine-co-dimethacrylate), poly(vinylamine-co-diacrylate), poly(vinylamine-co-1,4-butanediol divinyl ether), poly(vinylamine-co-1,4-pentantane-3-ol), poly(vinylamine-co-divinyl sulfone), poly(N-methylvinylamine-co-dimethacrylate), poly(N-methylvinylamine-co-diacrylate), poly(N-methylvinylamine-co-1,4-butanediol divinyl ether), poly(N-methylvinylamine-co-1,4-pentantane-3-ol), poly(N-methylvinylamine-co-divinyl sulfone), poly(N,N-dimethylvinylamine-co-dimethacrylate), poly(N,N-dimethylvinylamine-co-diacrylate), poly(N,N-dimethylvinylamine-co-1,4-butanediol divinyl ether), poly(N,N-dimethylvinylamine-co-1,4-pentantane-3-ol), poly(N,N-dimethylvinylamine-co-1,4-pentantane-3-ol), poly(N,N-dimethylvinylamine-co-divinyl sulfone), poly(N-methyl-N-ethylvinylamine-co-dimethacrylane), poly(N-methyl-N-ethylvinylamine-co-diacrylate), poly(N-methyl-N-ethylvinylamine-co-1,4-butanediol divinyl ether), poly(N-methyl-N-ethylvinylamine-co-1,4,-pentane-3-ol), poly(N-methyl-N-ethylvinylamine-co-divinyl sulfone), poly(N,N-diethylvinylamine-co-dimethacrylane), poly(N-methyl-N-ethylvinylamine-co-diacrylate), poly(N,N-diethylvinylamine-co-1,4-butanediol divinyl ether), and poly(N,N-diethylvinylamine-co-1,4,-pentane-3-ol), and poly(N,N-diethylvinylamine-co-divinyl sulfone).

10. The method as claimed in claim 7, wherein the solution containing ions comprises an anion and a cation, and the cation is selected from a group consisting of: a proton, an inorganic cation, an organic acid, a metal cation, Li(I), Na(I), K(I), Cu(I), Rb(I), Ag(I), Cs(I), Au(I), Hg(I), Tl(I), At(I), Fr(I), Be(II), Mg(II), Ca(II), Ti(II), Cr(II), Mn(II), Fe(II), Co(II), Ni(II), Cu(II), Zn(II), Ge(II), Sr(II), Pd(II), Cd(II), Sn(II), Te(II), Ba(II), Pt(II), Hg(II), Pb(II), Po(II), Ra(II), Eu(II), s(II), Yb(II), No(II), Sc(III), Ti(III), V(III), Cr(III), Mn(III), Fe(III), Co(III), Ni(III), Ga(III), As(III), Y(III), Nb(III), Ru(III), In(III), Sb(III), La(III), Os(III), Ir(III), Au(III), Tl(III), Bi(III), Ac(III), Ce(III), Pr(III), Nd(III), Pm(III), Sm(III), Eu(III), Gd(III), Tb(III), Dy(III), Ho(III), Er(III), Tm(III), Yb(III), Lu(III), U(III), Np(III), Pu(III), Am(III), Cm(III), Bk(III), Cf(III), Es(III), Fm(III), Md(III), No(III), Lr(III), Ti(IV), V(IV), Mn(IV), Ge(IV), Zr(IV), Tc(IV), Pd(IV), Sn(IV), Te(IV), Hf(IV), Re(IV), Os(IV), Ir(IV), Pt(IV), Pb(IV), Po(IV), Ce(IV), Pa(IV), U(IV), Np(IV), Pu(IV), Am(IV), and Bk(IV), V(V), As(V), Nb(V), Sb(V), Ta(V), Bi(V), Pa(V), U(V), Np(V), Pu(V), Am(V), Cr(VI), Mo(VI), Tc(VI), Te(VI), W(VI), Re(VI), U(VI), Np(VI), Pu(VI), Am(VI), Mn(VII), Tc(VII), Re(VII), a rare earth element, lanthanum, cerium, praseodymium, neodymium, promethium, samarium, europium, gadolinium, terbium, dysprosium, holmium, erbium, thulium, ytterbium, lutetium, scandium, yttrium, and a dye.

11. The method as claimed in claim 7, wherein:
the cross-linking segments comprise divinylbenzene,
the weak base anion resin comprises a polymer selected from a group consisting of: poly(vinylamine-co-divinylbenzene), poly(N-methylvinylamine-co-divinylbenzene), poly(N,N-dimethylvinylamine-co-divinylbenzene), poly(N-methyl-N-ethylvinylamine-co-divinylbenzene), and poly(N,N-diethylvinylamine-co-divinylbenzene), the solution containing ions comprises an anion and a cation, and the cation is selected from a group consisting of: a proton, an inorganic cation, an organic acid, a metal cation, Li(I), Na(I), K(I), Cu(I), Rb(I), Ag(I), Cs(I), Au(I), Hg(I), Tl(I), At(I), Fr(I), Be(II), Mg(II), Ca(II), Ti(II), Cr(II), Mn(II), Fe(II), Co(II), Ni(II), Cu(II), Zn(II), Ge(II), Sr(II), Pd(II), Cd(II), Sn(II), Te(II), Ba(II), Pt(II), Hg(II), Pb(II), Po(II), Ra(II), Eu(II), s(II), Yb(II), No(II), Sc(III), Ti(III), V(III), Cr(III), Mn(III), Fe(III), Co(III), Ni(III), Ga(III), As(III), Y(III), Nb(III), Ru(III), In(III), Sb(III), La(III), Os(III), Ir(III), Au(III), Tl(III), Bi(III), Ac(III), Ce(III), Pr(III), Nd(III), Pm(III), Sm(III), Eu(III), Gd(III), Tb(III), Dy(III), Ho(III), Er(III), Tm(III), Yb(III), Lu(III), U(III), Np(III), Pu(III), Am(III), Cm(III), Bk(III), Cf(III), Es(III), Fm(III), Md(III), No(III), Lr(III), Ti(IV), V(IV), Mn(IV), Ge(IV), Zr(IV), Tc(IV), Pd(IV), Sn(IV), Te(IV), Hf(IV), Re(IV), Os(IV), Ir(IV), Pt(IV), Pb(IV), Po(IV), Ce(IV), Pa(IV), U(IV), Np(IV), Pu(IV), Am(IV), and Bk(IV), V(V), As(V), Nb(V), Sb(V), Ta(V), Bi(V), Pa(V), U(V), Np(V), Pu(V), Am(V), Cr(VI), Mo(VI), Tc(VI), Te(VI), W(VI), Re(VI), U(VI), Np(VI), Pu(VI), Am(VI), Mn(VII), Tc(VII), Re(VII), a rare earth element, lanthanum, cerium, praseodymium, neodymium, promethium, samarium, europium, gadolinium, terbium, dysprosium, holmium, erbium, thulium, ytterbium, lutetium, scandium, yttrium, and a dye.

12. The method as claimed in claim 7, wherein:
the cross-linking segments are selected from a group consisting of: diacrylate, dimethacrylate, 1,4-butanediol divinyl ether, 1,4-pentantane-3-ol, 1,4-butanediol divinyl ether, 1,4-pentantane-3-ol, and divinyl sulfone,
the weak base anion resin comprises a polymer selected from a group consisting of: poly(vinylamine-co-dimethacrylate), poly(vinylamine-co-diacrylate), poly(vinylamine-co-1,4-butanediol divinyl ether), poly(vinylamine-co-1,4-pentantane-3-ol), poly(vinylamine-co-divinyl sulfone), poly(N-methylvinylamine-co-dimethacrylate), poly(N-methylvinylamine-co-diacrylate), poly(N-methylvinylamine-co-1,4-butanediol divinyl ether), poly(N-methylvinylamine-co-1,4-pentantane-3-ol), poly(N-methylvinylamine-co-divinyl sulfone), poly(N,N-dimethylvinylamine-co-dimethacrylate), poly(N,N-dimethylvinylamine-co-diacrylate), poly(N,N-dimethylvinylamine-co-1,4-butanediol divinyl ether), poly(N,N-dimethylvinylamine-co-1,4-pentantane-3-ol), poly(N,N-dimethylvinylamine-co-1,4-pentantane-3-ol), poly(N,N-dimethylvinylamine-co-divinyl sulfone), poly(N-methyl-N-ethylvinylamine-co-dimethacrylane), poly(N-methyl-N-ethylvinylamine-co-diacrylate), poly(N-methyl-N-ethylvinylamine-co-1,4-butanediol divinyl ether), poly(N-methyl-N-ethylvinylamine-co-1,4,-pentane-3-ol), poly(N-methyl-N-ethylvinylamine-co-divinyl sulfone), poly(N,N-diethylvinylamine-co-dimethacrylane), poly(N-methyl-N-ethylvinylamine-co-diacrylate), poly(N,N-diethylvinylamine-co-1,4-butanediol divinyl ether), and poly(N,N-diethylvinylamine-co-1,4,-pentane-3-ol), and poly(N,N-diethylvinylamine-co-divinyl sulfone), and
the solution containing ions comprises an anion and a cation, and the cation is selected from a group consisting of: a proton, an inorganic cation, an organic acid, a metal cation, Li(I), Na(I), K(I), Cu(I), Rb(I), Ag(I), Cs(I), Au(I), Hg(I), Tl(I), At(I), Fr(I), Be(II), Mg(II), Ca(II), Ti(II), Cr(II), Mn(II), Fe(II), Co(II), Ni(II), Cu(II), Zn(II), Ge(II), Sr(II), Pd(II), Cd(II), Sn(II), Te(II), Ba(II), Pt(II), Hg(II), Pb(II), Po(II), Ra(II), Eu(II), Sm(II), Yb(II), No(II), Sc(III), Ti(III), V(III), Cr(III), Mn(III), Fe(III), Co(III), Ni(III), Ga(III), As(III), Y(III), Nb(III), Ru(III), In(III), Sb(III), La(III), Os(III), Ir(III), Au(III), Tl(III), Bi(III), Ac(III), Ce(III), Pr(III), Nd(III), Pm(III), Sm(III), Eu(III), Gd(III), Tb(III), Dy(III), Ho(III), Er(III), Tm(III), Yb(III), Lu(III), U(III), Np(III), Pu(III), Am(III), Cm(III), Bk(III), Cf(III), Es(III), Fm(III), Md(III), No(III), Lr(III), Ti(IV), V(IV), Mn(IV), Ge(IV), Zr(IV), Tc(IV), Pd(IV), Sn(IV), Te(IV), Hf(IV), Re(IV), Os(IV), Ir(IV), Pt(IV), Pb(IV), Po(IV), Ce(IV), Pa(IV), U(IV), Np(IV), Pu(IV), Am(IV), and Bk(IV), V(V), As(V), Nb(V), Sb(V), Ta(V), Bi(V), Pa(V), U(V), Np(V), Pu(V), Am(V), Cr(VI), Mo(VI), Tc(VI), Te(VI), W(VI), Re(VI), U(VI), Np(VI), Pu(VI), Am(VI), Mn(VII), Tc(VII), Re(VII), a rare earth element, lanthanum, cerium, praseodymium, neodymium, promethium, samarium, europium, gadolinium, terbium, dysprosium, holmium, erbium, thulium, ytterbium, lutetium, scandium, yttrium, and a dye.

13. A method to capture and release an acid gas, the method comprising:
providing a weak base anion resin;
contacting the weak base anion resin with a gas comprising an acid gas to one of capture or adsorb the acid gas from the gas to the weak base anion resin; and
regenerating the weak base anion resin to release the acid gas, the weak base anion resin comprising alkylamine segments covalently bound to cross-linking segments, the alkylamine segments being selected from a group consisting of: vinylamine, N-methylvinylamine, N,N-dimethylvinylamine, N-methyl-N-ethylvinylamine, and N,N-diethylvinylamine, and the weak base anion resin further comprises ions adsorbed to the alkylamine segments.

14. The method as claimed in claim 13, wherein the acid gas is selected from a group consisting of: sulfur oxide, sulfur monoxide, sulfur dioxide, sulfur trioxide, nitrogen oxide, nitrogen dioxide, nitrogen trioxide, nitrous oxide, dinitrogen dioxide, dinitrogen trioxide, dinitrogen tetroxide, dinitrogen pentoxide, nitrosylazide, oxatetrazol, trinitramide, hydrogen sulfide, and carbon dioxide.

15. The method as claimed in claim 13, wherein:
the cross-linking segments comprise divinylbenzene, and
the weak base anion resin comprises a polymer selected from a group consisting of: poly(vinylamine-co-divinylbenzene), poly(N-methylvinylamine-co-divinylbenzene), poly(N,N-dimethylvinylamine-co-divinylbenzene), poly(N-methyl-N-ethylvinylamine-co-divinylbenzene), and poly(N,N-diethylvinylamine-co-divinylbenzene).

16. The method as claimed in claim 13, wherein:
the cross-linking segments are selected from a group consisting of: diacrylate, dimethacrylate, 1,4-butanediol divinyl ether, 1,4-pentantane-3-ol, 1,4-butanediol divinyl ether, 1,4-pentantane-3-ol, and divinyl sulfone, and
the weak base anion resin comprises a polymer selected from a group consisting of: poly(vinylamine-co-dimethacrylate), poly(vinylamine-co-diacrylate), poly(vinylamine-co-1,4-butanediol divinyl ether), poly(vinylamine-co-1,4-pentantane-3-ol), poly(vinylamine-co-divinyl sulfone), poly(N-methylvinylamine-co-dimethacrylate), poly(N-methylvinylamine-co-diacrylate), poly(N-methylvinylamine-co-1,4-butanediol divinyl ether), poly(N-methylvinylamine-co-1,4-pentantane-3-ol), poly(N-methylvinylamine-co-divinyl sulfone), poly(N,N-dimethylvinylamine-co-dimethacrylate), poly(N,N-dimethylvinylamine-co-diacrylate), poly(N,N-dimethylvinylamine-co-1,4-butanediol divinyl ether), poly(N,N-dimethylvinylamine-co-1,4-pentantane-3-ol), poly(N,N-dimethylvinylamine-co-1,4-pentantane-3-ol), poly(N,N-dimethylvinylamine-co-divinyl sulfone), poly(N-methyl-N-ethylvinylamine-co-dimethacrylane), poly(N-methyl-N-ethylvinylamine-co-diacrylate), poly(N-methyl-N-ethylvinylamine-co-1,4-butanediol divinyl ether), poly(N-methyl-N-ethylvinylamine-co-1,4,-pentane-3-ol), poly(N-methyl-N-ethylvinylamine-co-divinyl sulfone), poly(N,N-diethylvinylamine-co-dimethacrylane), poly(N-methyl-N-ethylvinylamine-co-diacrylate), poly(N,N-diethylvinylamine-co-1,4-butanediol divinyl ether), and poly(N,N-diethylvinylamine-co-1,4,-pentane-3-ol), and poly(N,N-diethylvinylamine-co-divinyl sulfone).

17. The method as claimed in claim 13, wherein the ions are selected from the group consisting of: a proton, an inorganic cation, an organic acid, a metal cation, Li(I), Na(I), K(I), Cu(I), Rb(I), Ag(I), Cs(I), Au(I), Hg(I), Tl(I), At(I), Fr(I), Be(II), Mg(II), Ca(II), Ti(II), Cr(II), Mn(II), Fe(II), Co(II), Ni(II), Cu(II), Zn(II), Ge(II), Sr(II), Pd(II), Cd(II), Sn(II), Te(II), Ba(II), Pt(II), Hg(II), Pb(II), Po(II), Ra(II), Eu(II), Sm(II), Yb(II), No(II), Sc(III), Ti(III), V(III), Cr(III), Mn(III), Fe(III), Co(III), Ni(III), Ga(III), As(III), Y(III), Nb(III), Ru(III), In(III), Sb(III), La(III), Os(III), Ir(III), Au(III), Tl(III), Bi(III), Ac(III), Ce(III), Pr(III), Nd(III), Pm(III), Sm(III), Eu(III), Gd(III), Tb(III), Dy(III), Ho(III), Er(III), Tm(III), Yb(III), Lu(III), U(III), Np(III), Pu(III), Am(III), Cm(III), Bk(III), Cf(III), Es(III), Fm(III), Md(III), No(III), Lr(III), Ti(IV), V(IV), Mn(IV), Ge(IV), Zr(IV), Tc(IV), Pd(IV), Sn(IV), Te(IV), Hf(IV), Re(IV), Os(IV), Ir(IV), Pt(IV), Pb(IV), Po(IV), Ce(IV), Pa(IV), U(IV), Np(IV), Pu(IV), Am(IV), and Bk(IV), V(V), As(V), Nb(V), Sb(V), Ta(V), Bi(V), Pa(V), U(V), Np(V), Pu(V), Am(V), Cr(VI), Mo(VI), Tc(VI), Te(VI), W(VI), Re(VI), U(VI), Np(VI), Pu(VI), Am(VI), Mn(VII), Tc(VII), Re(VII), a rare earth element, lanthanum, cerium, praseodymium, neodymium, promethium, samarium, europium, gadolinium, terbium, dysprosium, holmium, erbium, thulium, ytterbium, lutetium, scandium, yttrium, and a dye.

18. The method as claimed in claim 13, wherein:
the cross-linking segments comprise divinylbenzene,
the weak base anion resin comprises a polymer selected from a group consisting of: poly(vinylamine-co-divinylbenzene), poly(N-methylvinylamine-co-divinylbenzene), poly(N,N-dimethylvinylamine-co-divinylbenzene), poly(N-methyl-N-ethylvinylamine-co-divinylbenzene), and poly(N,N-diethylvinylamine-co-divinylbenzene), and
the ions comprise an anion and a cation, and wherein the cation is selected from a group consisting of: a proton, an inorganic cation, an organic acid, a metal cation, Li(I), Na(I), K(I), Cu(I), Rb(I), Ag(I), Cs(I), Au(I), Hg(I), Tl(I), At(I), Fr(I), Be(II), Mg(II), Ca(II), Ti(II), Cr(II), Mn(II), Fe(II), Co(II), Ni(II), Cu(II), Zn(II), Ge(II), Sr(II), Pd(II), Cd(II), Sn(II), Te(II), Ba(II), Pt(II), Hg(II), Pb(II), Po(II), Ra(II), Eu(II), Sm(II), Yb(II), No(II), Sc(III), Ti(III), V(III), Cr(III), Mn(III), Fe(III), Co(III), Ni(III), Ga(III), As(III), Y(III), Nb(III), Ru(III), In(III), Sb(III), La(III), Os(III), Ir(III), Au(III), Tl(III), Bi(III), Ac(III), Ce(III), Pr(III), Nd(III), Pm(III), Sm(III), Eu(III), Gd(III), Tb(III), Dy(III), Ho(III), Er(III), Tm(III), Yb(III), Lu(III), U(III), Np(III), Pu(III), Am(III), Cm(III), Bk(III), Cf(III), Es(III), Fm(III), Md(III), No(III), Lr(III), Ti(IV), V(IV), Mn(IV), Ge(IV), Zr(IV), Tc(IV), Pd(IV), Sn(IV), Te(IV), Hf(IV), Re(IV), Os(IV), Ir(IV), Pt(IV), Pb(IV), Po(IV), Ce(IV), Pa(IV), U(IV), Np(IV), Pu(IV), Am(IV), and Bk(IV), V(V), As(V), Nb(V), Sb(V), Ta(V), Bi(V), Pa(V), U(V), Np(V), Pu(V), Am(V), Cr(VI), Mo(VI), Tc(VI), Te(VI), W(VI), Re(VI), U(VI), Np(VI), Pu(VI), Am(VI), Mn(VII), Tc(VII), Re(VII), a rare earth element, lanthanum, cerium, praseodymium, neodymium, promethium, samarium, europium, gadolinium, terbium, dysprosium, holmium, erbium, thulium, ytterbium, lutetium, scandium, yttrium, and a dye.

19. The method as claimed in claim 13, wherein:
the cross-linking segments comprise divinylbenzene,
the weak base anion resin comprises a polymer selected from a group consisting of: poly(vinylamine-co-divinylbenzene), poly(N-methylvinylamine-co-divinylbenzene), poly(N,N-dimethylvinylamine-co-divinylbenzene), poly(N-methyl-N-ethylvinylamine-co-divinylbenzene), and poly(N,N-diethylvinylamine-co-divinylbenzene), and
the ions comprise an anion and a cation, wherein the cation is selected from a group consisting of: a proton, an inorganic cation, an organic acid, a metal cation, Li(I), Na(I), K(I), Cu(I), Rb(I), Ag(I), Cs(I), Au(I), Hg(I), Tl(I), At(I), Fr(I), Be(II), Mg(II), Ca(II), Ti(II), Cr(II), Mn(II), Fe(II), Co(II), Ni(II), Cu(II), Zn(II), Ge(II), Sr(II), Pd(II), Cd(II), Sn(II), Te(II), Ba(II), Pt(II), Hg(II), Pb(II), Po(II), Ra(II), Eu(II), Sm(II), Yb(II), No(II), Sc(III), Ti(III), V(III), Cr(III), Mn(III), Fe(III), Co(III), Ni(III), Ga(III), As(III), Y(III), Nb(III), Ru(III), In(III), Sb(III), La(III), Os(III), Ir(III), Au(III), Tl(III), Bi(III), Ac(III), Ce(III), Pr(III), Nd(III), Pm(III), Sm(III), Eu(III), Gd(III), Tb(III), Dy(III), Ho(III), Er(III), Tm(III), Yb(III), Lu(III), U(III), Np(III), Pu(III), Am(III), Cm(III), Bk(III), Cf(III), Es(III), Fm(III), Md(III), No(III), Lr(III), Ti(IV), V(IV), Mn(IV), Ge(IV), Zr(IV), Tc(IV), Pd(IV), Sn(IV), Te(IV), Hf(IV), Re(IV), Os(IV), Ir(IV), Pt(IV), Pb(IV), Po(IV), Ce(IV), Pa(IV), U(IV), Np(IV), Pu(IV), Am(IV), and Bk(IV), V(V), As(V), Nb(V), Sb(V), Ta(V), Bi(V), Pa(V), U(V), Np(V), Pu(V), Am(V), Cr(VI), Mo(VI), Tc(VI), Te(VI), W(VI), Re(VI), U(VI), Np(VI), Pu(VI), Am(VI), Mn(VII), Tc(VII), Re(VII), a rare earth element, lanthanum, cerium, praseodymium, neodymium, promethium, samarium, europium, gadolinium, terbium, dysprosium, holmium, erbium, thulium, ytterbium, lutetium, scandium, yttrium, and a dye, and wherein the acid gas is selected from a group consisting of: sulfur oxide, sulfur monoxide, sulfur dioxide, sulfur trioxide, nitrogen oxide, nitrogen dioxide, nitrogen trioxide, nitrous oxide, dinitrogen dioxide, dinitrogen trioxide, dinitrogen tetroxide, dinitrogen pentoxide, nitrosylazide, oxatetrazol, trinitramide, hydrogen sulfide, and carbon dioxide.

20. The method as claimed in claim 13, wherein:
the cross-linking segments are selected from a group consisting of: diacrylate, dimethacrylate, 1,4-butanediol divinyl ether, 1,4-pentantane-3-ol, 1,4-butanediol divinyl ether, 1,4-pentantane-3-ol, and divinyl sulfone, and
the weak base anion resin comprises a polymer selected from a group consisting of: poly(vinylamine-co-dimethacrylate), poly(vinylamine-co-diacrylate), poly(vinylamine-co-1,4-butanediol divinyl ether), poly(vinylamine-co-1,4-pentantane-3-ol), poly(vinylamine-co-divinyl sulfone), poly(N-methylvinylamine-co-dimethacrylate), poly(N-methylvinylamine-co-diacrylate), poly(N-methylvinylamine-co-1,4-butanediol divinyl ether), poly(N-methylvinylamine-co-1,4-pentantane-3-ol), poly(N-methylvinylamine-co-divinyl sulfone), poly(N,N-dimethylvinylamine-co-dimethacrylate), poly(N,N-dimethylvinylamine-co-diacrylate), poly(N,N-dimethylvinylamine-co-1,4-butanediol divinyl ether), poly(N,N-dimethylvinylamine-co-1,4-pentantane-3-ol), poly(N,N-dimethylvinylamine-co-1,4-pentantane-3-ol), poly(N,N-dimethylvinylamine-co-divinyl sulfone), poly(N-methyl-N-ethylvinylamine-co-dimethacrylane), poly(N-methyl-N-ethylvinylamine-co-diacrylate), poly(N-methyl-N-ethylvinylamine-co-1,4-butanediol divinyl ether), poly(N-methyl-N-ethylvinylamine-co-1,4,-pentane-3-ol), poly(N-methyl-N-ethylvinylamine-co-divinyl sulfone), poly(N,N-diethylvinylamine-co-dimethacrylane), poly(N-methyl-N-ethylvinylamine-co-diacrylate), poly(N,N-diethylvinylamine-co-1,4-butanediol divinyl ether), and poly(N,N-diethylvinylamine-co-1,4,-pentane-3-ol), and poly(N,N-diethylvinylamine-co-divinyl sulfone), and the ions comprise an anion and a cation, and the cation is selected from a group consisting of: a proton, an inorganic cation, an organic acid, a metal cation, Li(I), Na(I), K(I), Cu(I), Rb(I), Ag(I), Cs(I), Au(I), Hg(I), Tl(I), At(I), Fr(I), Be(II), Mg(II), Ca(II), Ti(II), Cr(II), Mn(II), Fe(II), Co(II), Ni(II), Cu(II), Zn(II), Ge(II), Sr(II), Pd(II), Cd(II), Sn(II), Te(II), Ba(II), Pt(II), Hg(II), Pb(II), Po(II), Ra(II), Eu(II), Sm(II), Yb(II), No(II), Sc(III), Ti(III), V(III), Cr(III), Mn(III), Fe(III), Co(III), Ni(III), Ga(III), As(III), Y(III), Nb(III), Ru(III), In(III), Sb(III), La(III), Os(III), Ir(III), Au(III), Tl(III), Bi(III), Ac(III), Ce(III), Pr(III), Nd(III), Pm(III), Sm(III), Eu(III), Gd(III), Tb(III), Dy(III), Ho(III), Er(III), Tm(III), Yb(III), Lu(III), U(III), Np(III), Pu(III), Am(III), Cm(III), Bk(III), Cf(III), Es(III), Fm(III), Md(III), No(III), Lr(III), Ti(IV), V(IV), Mn(IV), Ge(IV), Zr(IV), Tc(IV), Pd(IV), Sn(IV), Te(IV), Hf(IV), Re(IV), Os(IV), Ir(IV), Pt(IV), Pb(IV), Po(IV), Ce(IV), Pa(IV), U(IV), Np(IV), Pu(IV), Am(IV), and Bk(IV), V(V), As(V), Nb(V), Sb(V), Ta(V), Bi(V), Pa(V), U(V), Np(V), Pu(V), Am(V), Cr(VI), Mo(VI), Tc(VI), Te(VI), W(VI), Re(VI), U(VI), Np(VI), Pu(VI), Am(VI), Mn(VII), Tc(VII), Re(VII), a rare earth element, lanthanum, cerium, praseodymium, neodymium, promethium, samarium, europium, gadolinium, terbium, dysprosium, holmium, erbium, thulium, ytterbium, lutetium, scandium, yttrium, and a dye, and wherein the acid gas is selected from a group consisting of: sulfur oxide, sulfur monoxide, sulfur dioxide, sulfur trioxide, nitrogen oxide, nitrogen dioxide, nitrogen trioxide, nitrous oxide, dinitrogen dioxide, dinitrogen trioxide, dinitrogen tetroxide, dinitrogen pentoxide, nitrosylazide, oxatetrazol, trinitramide, hydrogen sulfide, and carbon dioxide.
